(19) United States
(12) Patent Application Publication
(10) Pub. No.: US 2010/0085935 A1
(43) Pub. Date: Apr. 8, 2010

(54) METHODS AND APPARATUS FOR SUPPORTING SHORT BURST MESSAGES OVER WIRELSS COMMUNICATION NETWORKS

(75) Inventor: Tom Chin, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/246,472

(22) Filed: Oct. 6, 2008

(51) Int. Cl. H04W 36/00

(52) U.S. Cl. 370/331

(57) ABSTRACT

A multi-mode mobile station may include an extended preferred roaming list (PRL). The extended PRL may include an extended system table. The extended system table may include at least one WiMAX extended system record and at least one CDMA extended system record. The extended PRL may also include an extended acquisition table. The extended acquisition table may also include at least one WiMAX extended acquisition record and at least one CDMA extended acquisition record.

### TECHNICAL FIELD

The present disclosure relates generally to communication systems. More specifically, the present disclosure relates to a preferred roaming list (PRL) for a CDMA and a WiMAX multi-mode system.

### BACKGROUND

Wireless communication systems have become an important means by which many people worldwide have come to communicate. A wireless communication system may provide communication for a number of mobile stations, each of which may be serviced by a base station. As used herein, the term “mobile station” refers to an electronic device that may be used for voice and/or data communication over a wireless communication system. Examples of mobile stations include cellular phones, personal digital assistants (PDAs), handheld devices, wireless modems, laptop computers, personal computers, etc. A mobile station may alternatively be referred to as an access terminal, a mobile terminal, a subscriber station, a remote station, a user terminal, a terminal, a subscriber unit, a mobile device, a wireless device, user equipment, or some other similar terminology. The term “base station” refers to a wireless communication station that is installed at a fixed location and used to communicate with mobile stations. A base station may alternatively be referred to as an access point, a Node B, an evolved Node B, or some other similar terminology.

A mobile station may communicate with one or more base stations via transmissions on the uplink and the downlink. The uplink (or reverse link) refers to the communication link from the mobile station to the base station, and the downlink (or forward link) refers to the communication link from the base station to the mobile station.

The resources of a wireless communication system (e.g., bandwidth and transmit power) may be shared among multiple mobile stations. A variety of multiple access techniques are known, including code division multiple access (CDMA), time division multiple access (TDMA), frequency division multiple access (FDMA), orthogonal frequency division multiple access (OFDMA), frequency division multiple access (SC-FDMA), and so forth.

Benefits may be realized by improved methods and apparatus related to the operation of wireless communication systems.

### BRIEF DESCRIPTION OF THE DRAWINGS

FIG. 1 shows an example of a wireless communication system in which the methods disclosed herein may be utilized;

FIG. 2 illustrates a mobile station that includes an extended preferred roaming list (PRL) in accordance with the present disclosure;

FIG. 3 illustrates a method for improved roaming for a multi-mode mobile station;

FIG. 4 illustrates means-plus-function blocks corresponding to the method of FIG. 3;

FIG. 5 illustrates certain aspects of the extended PRL;

FIG. 6 illustrates certain additional aspects of the extended PRL;

FIG. 7 illustrates an extended system record in greater detail;

FIG. 8 illustrates an extended acquisition record in greater detail; and

FIG. 9 illustrates certain components that may be included within a wireless device.

### SUMMARY

A multi-mode mobile station is disclosed. The multi-mode mobile station may include an extended preferred roaming list (PRL). The extended PRL may include an extended system table. The extended system table may include at least one WiMAX extended system record and at least one CDMA extended system record. The extended PRL may also include an extended acquisition table. The extended acquisition table may also include at least one WiMAX extended acquisition record and at least one CDMA extended acquisition record.

A method for improved roaming for a multi-mode mobile station is disclosed. The method may include accessing an extended preferred roaming list (PRL) that comprises information about at least one CDMA system and information about at least one WiMAX system. The method may also include scanning for available systems using the CDMA system information and the WiMAX system information contained in the extended PRL. The method may also include acquiring the at least one WiMAX system using the WiMAX system information.

A multi-mode mobile station is disclosed. The multi-mode mobile station may include means for accessing an extended preferred roaming list (PRL) that comprises information about at least one CDMA system and information about at least one WiMAX system. The multi-mode mobile station may also include means for scanning for available systems using the CDMA system information and the WiMAX system information contained in the extended PRL. The multi-mode mobile station may also include means for acquiring the at least one WiMAX system using the WiMAX system information.

A computer-program product is disclosed. The computer-program product may include a computer-readable medium having instructions thereon. The instructions may include code for accessing an extended preferred roaming list (PRL) that comprises information about at least one CDMA system and information about at least one WiMAX system. The instructions may also include code for scanning for available systems using the CDMA system information and the WiMAX system information contained in the extended PRL. The instructions may also include code for acquiring the at least one WiMAX system using the WiMAX system information.

### DETAILED DESCRIPTION

Wireless communication system users commonly have a service agreement with a wireless service provider. The system operated by a wireless service provider may cover a limited geographical area. When a user travels outside of this geographical area, service may be provided by another system operator. This may be referred to as roaming.

There may be more than one service provider in a particular region. To assist the mobile station in system selection while roaming, a mobile station may include a Preferred Roaming List (PRL). The PRL may indicate which systems the mobile station should use (preferred systems) and those which should not be used by the mobile station (prohibited systems). The PRL may also include information which can help to optimize the acquisition time.

A wireless communication system may be based on Code Division Multiple Access (CDMA). A CDMA system may be designed to support one or more CDMA standards such as IS-2000, IS-856, IS-95, Wideband CDMA (W-CDMA), and so on. IS-2000 is commonly known as CDMA 1x, IS-856 is commonly known as CDMA Evolution-Data Optimized (EV-DO), and both are parts of a cdma2000 family of standards.

A mobile station supporting CDMA 1x typically maintains a PRL that contains information to assist the mobile station perform system selection and acquisition on CDMA 1x systems. The PRL format for CDMA 1x systems is described in a document referred to as TIA/EIA/IS-683-A, entitled “Over-the-Air Service Provisioning of Mobile Stations in Spread Spectrum Standards.”

A mobile station supporting CDMA EV-DO also maintains a PRL for system selection and acquisition on CDMA EV-DO systems. The PRL format for CDMA EV-DO is described in a document referred to as TIA/EIA/IS-683-C, entitled “Over-the-Air Service Provisioning of Mobile Stations in Spread Spectrum Standards.” IS-683-C describes (1) a PRL format that is an updated version of the PRL format defined by IS-683-A and that may be used for CDMA 1x systems, and (2) an extended PRL format that may be used for both CDMA 1x and CDMA EV-DO systems.

A mobile station may be configured to receive service from both CDMA 1x systems and CDMA EV-DO systems. This type of mobile station may be referred to as a multi-mode mobile station, because it is configured for different modes of operation (i.e., a CDMA 1x mode and a CDMA EV-DO mode). A multi-mode mobile station may be configured to receive service from a CDMA EV-DO system when such a system is available, and to receive service from a CDMA 1x system when a CDMA EV-DO system is not available but a CDMA 1x system is available.

The IEEE 802.16 Working Group on Broadband Wireless Access Standards aims to prepare formal specifications for the global deployment of broadband Wireless Metropolitan Area Networks. Although the 802.16 family of standards is officially called WirelessMAN, it has been called “WiMAX” (which stands for the “Worldwide Interoperability for Microwave Access”) by an industry group called the WiMAX Forum. Thus, the term “WiMAX” refers to a standards-based broadband wireless technology that provides high-throughput broadband connections over long distances. The term “WiMAX system” refers to a wireless communication system that is configured in accordance with one or more WiMAX standards.

The bandwidth and range of WiMAX make it suitable for a number of potential applications, including providing data and telecommunications services, connecting Wi-Fi hotspots with other parts of the Internet, providing a wireless alternative to cable and digital subscriber line for “last mile” broadband access, providing portable connectivity, etc.

There are quite a few WiMAX systems that are currently deployed, and additional WiMAX systems are expected to be completed and deployed in the near future. Mobile stations may be developed that can receive service from a WiMAX system in addition to a CDMA system (e.g., a CDMA 1x system and/or a CDMA EV-DO system). However, if such a multi-mode mobile station were to use an extended PRL as presently defined, the mobile station may not be able to receive service from WiMAX systems while roaming. This is because the extended PRL, as presently defined, does not include information about WiMAX systems. The present disclosure proposes that the extended PRL should be enhanced to support system selection for WiMAX systems, in addition to CDMA 1x and CDMA EV-DO systems. In other words, the present disclosure proposes adding WiMAX-specific system information to the extended PRL. This may allow a multi-mode mobile station to be able to receive service from a WiMAX system while roaming.

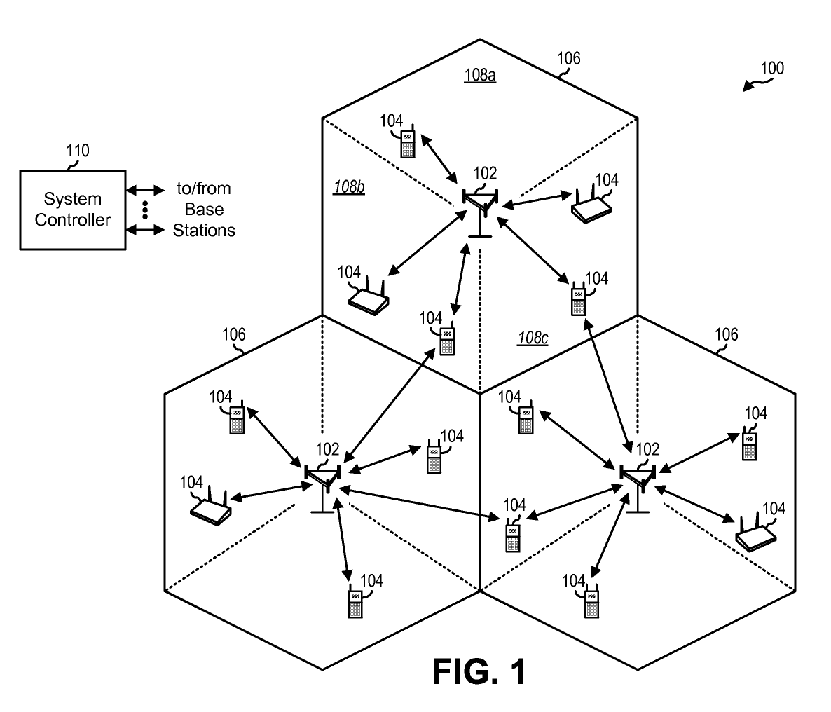

FIG. 1 shows an example of a wireless communication system 100 in which the methods disclosed herein may be utilized. The wireless communication system 100 includes multiple base stations (BS) 102 and multiple mobile stations (MS) 104. Each base station 102 provides communication coverage for a particular geographic area 106. The term “cell” can refer to a base station 102 and/or its coverage area 106 depending on the context in which the term is used.

To improve system capacity, a base station coverage area 106 may be partitioned into multiple smaller areas, e.g., three smaller areas 108a, 108b, and 108c. Each smaller area 108a, 108b, 108c may be served by a respective base transceiver station (BTS). The term “sector” can refer to a BTS and/or its coverage area 108 depending on the context in which the term is used. For a sectorized cell, the BTSs for all sectors of that cell are typically co-located within the base station 102 for the cell.

Mobile stations 104 are typically dispersed throughout the system 100. A mobile station 104 may communicate with zero, one, or multiple base stations 104 on the downlink and/or uplink at any given moment.

For a centralized architecture, a system controller 110 may couple to the base stations 102 and provide coordination and control for the base stations 102. The system controller 110 may be a single network entity or a collection of network entities. For a distributed architecture, base stations 102 may communicate with one another as needed.

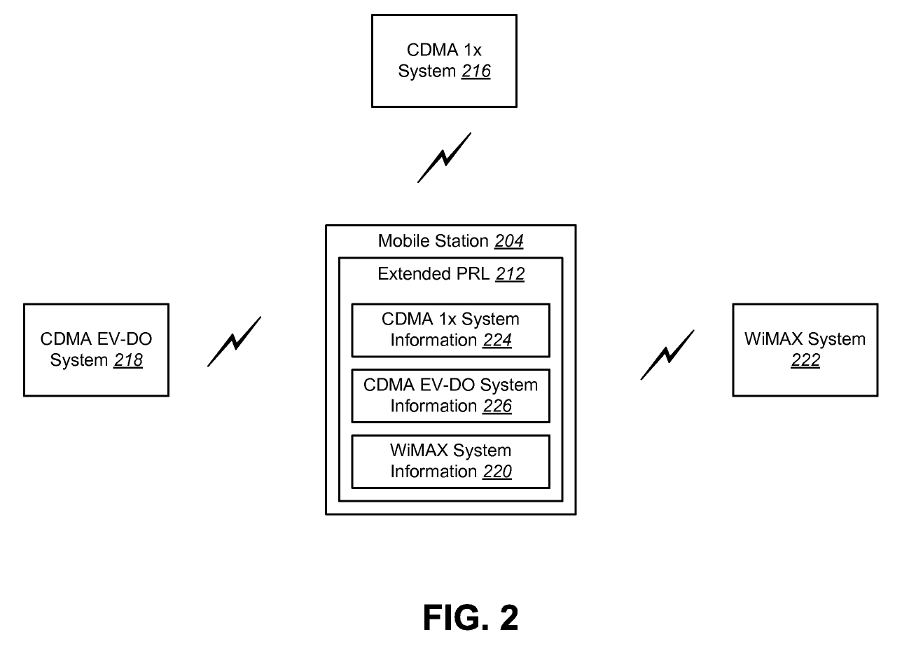

FIG. 2 illustrates a mobile station 204 that includes an extended PRL 212 in accordance with the present disclosure. The extended PRL 212 may include information 224 about one or more CDMA 1x systems 216, information 226 about one or more CDMA EV-DO systems 218, and information 220 about one or more WiMAX systems 222. The CDMA 1x system information 224 may assist the mobile station 204 to perform system selection and acquisition on CDMA 1x systems 216. The CDMA EV-DO system information 226 may assist the mobile station 204 to perform system selection and acquisition on CDMA EV-DO systems 218. The WiMAX system information 220 may assist the mobile station 204 to perform system selection and acquisition on WiMAX systems 222.

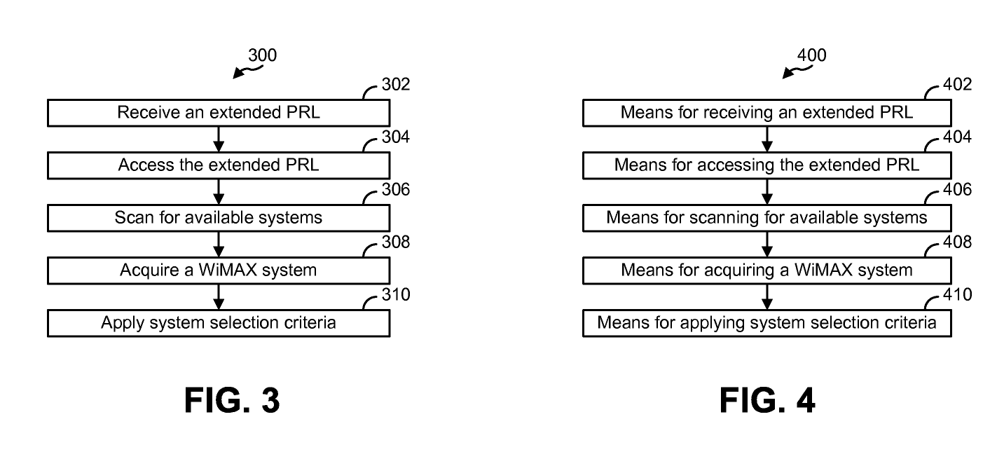

FIG. 3 illustrates a method 300 for improved roaming for a multi-mode mobile station 204. The method 300 may be implemented by a multi-mode mobile station 204 that is configured to receive service from a WiMAX system 222 and at least one CDMA system (e.g., a CDMA 1x system 216 and/or a CDMA EV-DO system 218).

In accordance with the depicted method 300, a multi-mode mobile station 204 may receive 302 an extended PRL 212. For example, the extended PRL 212 may be pre-programmed in the mobile station 204 when service is initiated. Alternatively, the extended PRL 212 can be programmed in the mobile station 204 with over-the-air data transfers.

At some point (e.g., when roaming), the mobile station 204 may access 304 the extended PRL 212 and scan 306 for available systems using the CDMA system information 224, 226 and the WiMAX system information 220 contained in the extended PRL 212. A WiMAX system 222 may be acquired 308. The mobile station 204 may apply 310 system selection criteria to the acquired WiMAX system 222. For example, the mobile station 204 may determine whether the acquired WiMAX system 222 is the most preferred system in the current geographic region. If not, the mobile station 204 may attempt to acquire a more preferred system.

The method 300 of FIG. 3 described above may be performed by various hardware and/or software component(s) and/or module(s) corresponding to the means-plus-function blocks 400 illustrated in FIG. 4. In other words, blocks 302 through 310 illustrated in FIG. 3 correspond to means-plus-function blocks 402 through 410 illustrated in FIG. 4.

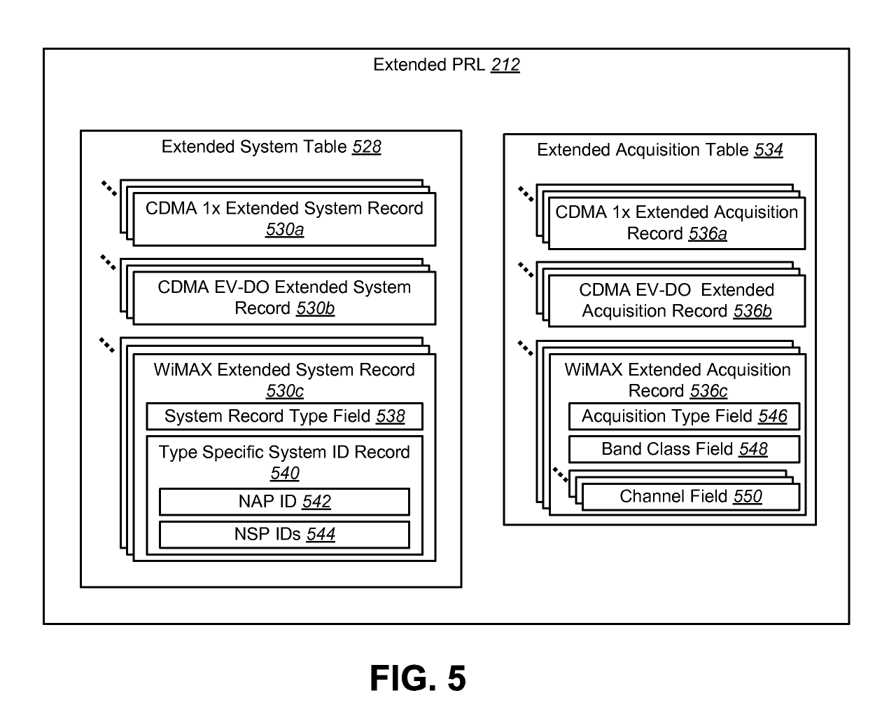

FIG. 5 illustrates certain aspects of the extended PRL 212. The extended PRL 212 may include an extended system table 528. The extended system table 528 may include multiple records 530, which may be referred to as extended system records 530.

The extended system table 528 may include one or more extended system records 530a corresponding to CDMA 1x systems 216, one or more extended system records 530b corresponding to CDMA EV-DO systems 218, and one or more extended system records 530c corresponding to WiMAX systems 222.

The extended PRL 212 may also include an extended acquisition table 534. The extended acquisition table 534 may include multiple records 536, which may be referred to as extended acquisition records 536. An extended acquisition record 536 may provide the information that the mobile station 204 is to use when searching to acquire a particular system. The extended acquisition records 536 may include one or more extended acquisition records 536a corresponding to CDMA 1x systems 216, one or more extended acquisition records 536b corresponding to CDMA EV-DO systems 218, and one or more extended acquisition records 536c corresponding to WiMAX systems 222.

The CDMA 1x extended system records 530a and the CDMA 1x extended acquisition records 536a are examples of CDMA 1x system information 224. The CDMA EV-DO extended system records 530b and the CDMA EV-DO extended acquisition records 536b are examples of CDMA EV-DO system information 226. The WiMAX extended system records 530c and the WiMAX extended acquisition records 536c are examples of WiMAX system information 220.

Each WiMAX extended system record 530c may include a system record type field 538 and a type specific system ID record 540. The system record type field 538 may be set to a value (e.g., 0b0100) specifically defined to indicate a WiMAX system 222. The type specific system ID record 540 may include the network access provider (NAP) ID 542. The type specific system ID record 540 may also include a list of network service provider (NSP) IDs 544. The NAP ID 542 and the NSP IDs 544 may each be 24-bit values.

Each WiMAX extended acquisition record 536c may include an acquisition type field 546. The acquisition type field 546 may be set to a value (e.g., 0b00010000) specifically defined to indicate a WiMAX system 222. Each WiMAX extended acquisition record 536c may also include a band class field 548 and one or more channel fields 550. Each of the channel fields 550 may indicate a channel corresponding to a WiMAX system 222. Each channel field 550 may include a frequency assignment (FA) index.

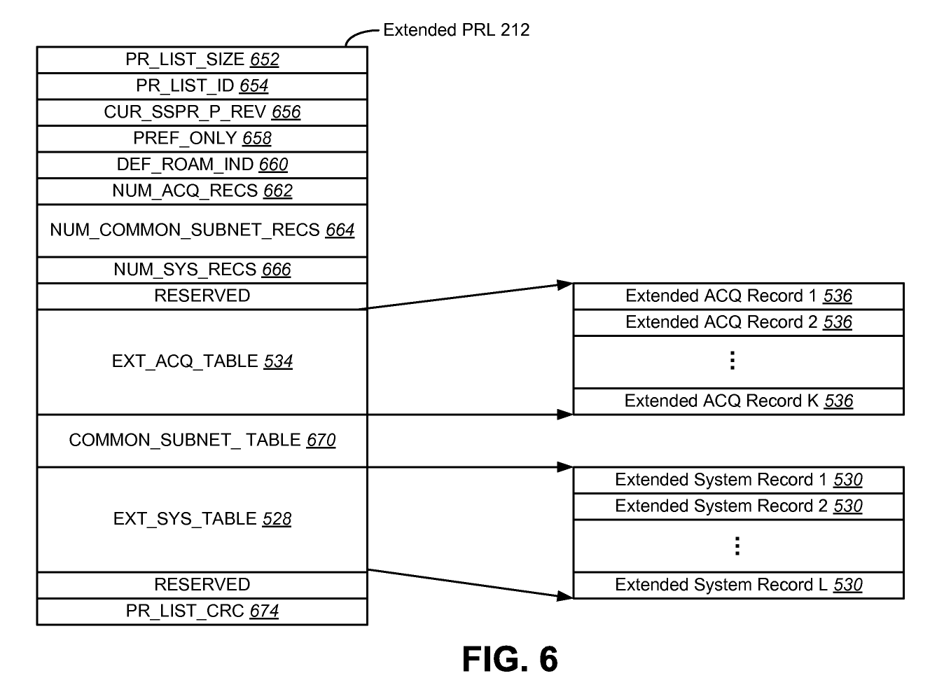

FIG. 6 illustrates certain additional aspects of the extended PRL 212. The extended PRL 212 may include a number of fields. A PR_LIST_SIZE field 652 may indicate the total size of the extended PRL 212. A PR_LIST_ID field 654 may be used to identify the extended PRL 212 (e.g., for purposes of version control). A CUR_SSPR_P_REV field 656 may indicate the protocol revision of a System Selection for Preferred Roaming (SSPR) download procedure that may determine the parsing rules for the extended PRL 212.

A PREF_ONLY field 658 may indicate whether only systems in the extended PRL 212 are to be used, or whether systems that are not described in the extended PRL 212 may be used. A DEF_ROAM_IND field 660 may indicate the roaming indication to be used for systems that are not described in the extended PRL 212. The DEF_ROAM_IND field 660 may apply when the PREF_ONLY field 658 indicates that systems that are not described in the extended PRL 212 may be used.

A NUM ACQ_RECS field 662 may indicate the number of records 536 in the extended acquisition table 534 (i.e., extended acquisition records 536). A NUM_COMMON_SUBNET_RECS field 664 may indicate the number of records in a common subnet table, which may include common portions of subnet-IDs. PRL compression may be achieved by listing common subnet prefixes only once in the common subnet table instead of many times in the extended system table 528. A NUM_SYS_RECS field 666 may indicate the number of records 530 in the extended system table 528 (i.e., extended system records 530).

The EXT ACQ_TABLE (extended acquisition table) 534 may include extended acquisition records 536. A COMMON_SUBNET_TABLE 670 may include records for a common subnet table. The EXT_SYS_TABLE (extended system table) 528 may include extended system records 530.

A PR_LIST_CRC field 674 may include a 16-bit cyclic redundancy check (CRC) value. This CRC value may be calculated for all fields of the extended PRL 212 except for the PR_LIST_CRC field 674.

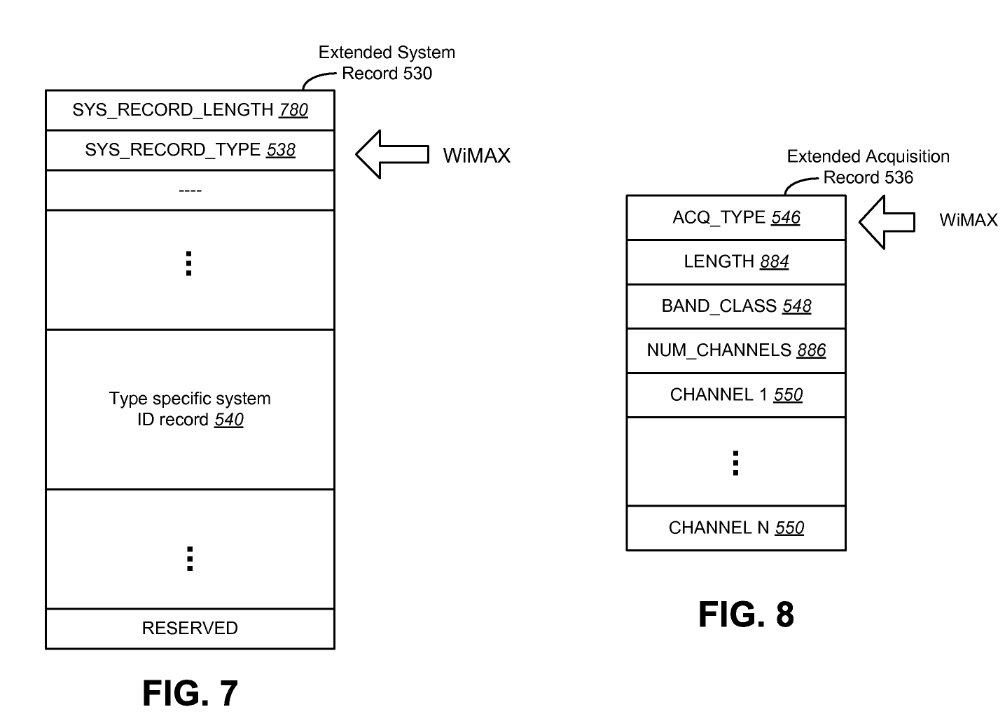

FIG. 7 illustrates an extended system record 530 in greater detail. The extended system record 530 may include a number of fields. A SYS_RECORD_LENGTH field 780 may indicate the length of the extended system record 530. The SYS_RECORD_TYPE (system record type) field 538 may indicate the type of wireless communication system to which the extended system record 530 corresponds. In an extended system record 530 that corresponds to a WiMAX system 222, the SYS_RECORD_TYPE field 538 may be set to a value (e.g., 0b0100) specifically defined to indicate a WiMAX system 222. The type specific system ID record 540 may include a NAP ID 542 and a list of NSP IDs 544.

FIG. 8 illustrates an extended acquisition record 536 in greater detail. The extended acquisition record 536 may include a number of fields. The ACQ_TYPE (acquisition type) field 546 may indicate the type of wireless communication system to which the extended acquisition record 536 corresponds. In an extended acquisition record 536 that corresponds to a WiMAX system 222, the ACQ_TYPE field 546 may be set to a value (e.g., 0b00010000) specifically defined to indicate a WiMAX system 222.

A LENGTH field 884 may indicate the length of the extended acquisition record 536. The BAND_CLASS field 548 may indicate a particular band class to which a WiMAX system 222 corresponds. A NUM_CHANNELS field 886 may indicate the number of CHANNEL fields 550 in the extended acquisition record 536. In an extended acquisition record 536 that corresponds to a WiMAX system 222, each CHANNEL field 550 may include a frequency assignment (FA) index for a channel corresponding to a WiMAX system 222.

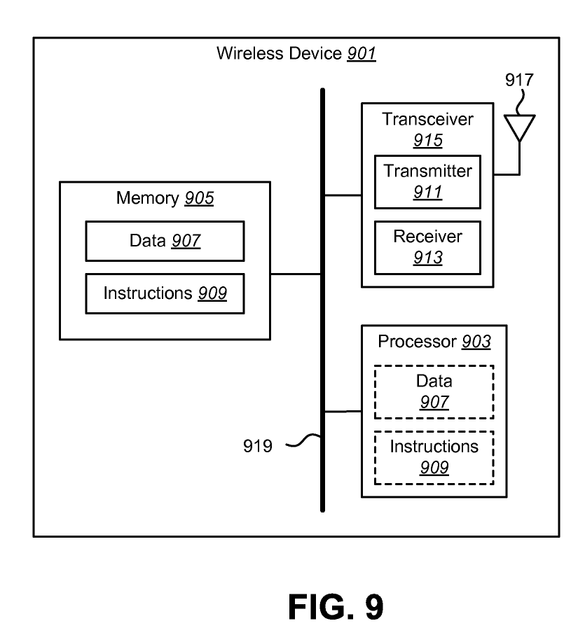

FIG. 9 illustrates certain components that may be included within a wireless device 901. The wireless device 901 may be a mobile station 104 or a base station 102.

The wireless device 901 includes a processor 903. The processor 903 may be a general purpose single- or multi-chip microprocessor (e.g., an ARM), a special purpose microprocessor (e.g., a digital signal processor (DSP)), a microcontroller, a programmable gate array, etc. The processor 903 may be referred to as a central processing unit (CPU). Although just a single processor 903 is shown in the wireless device 901 of FIG. 9, in an alternative configuration, a combination of processors (e.g., an ARM and DSP) could be used.

The wireless device 901 also includes memory 905. The memory 905 may be any electronic component capable of storing electronic information. The memory 905 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 907 and instructions 909 may be stored in the memory 905. The instructions 909 may be executable by the processor 903 to implement the methods disclosed herein. Executing the instructions 909 may involve the use of the data 907 that is stored in the memory 905.

The wireless device 901 may also include a transmitter 911 and a receiver 913 to allow transmission and reception of signals between the wireless device 901 and a remote location. The transmitter 911 and receiver 913 may be collectively referred to as a transceiver 915. An antenna 917 may be electrically coupled to the transceiver 915. The wireless device 901 may also include (not shown) multiple transmitters, multiple receivers, multiple transceivers and/or multiple antenna.

The various components of the wireless device 901 may be coupled together by one or more buses, which may include a power bus, a control signal bus, a status signal bus, a data bus, etc. For the sake of clarity, the various buses are illustrated in FIG. 9 as a bus system 919.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements. The terms “instructions” and “code” may be used interchangeably herein.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 3, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A multi-mode mobile station, comprising:
an extended preferred roaming list (PRL);
an extended system table within the extended PRL;
at least one code division multiple access (CDMA) extended system record within the extended system table;
at least one WiMAX extended system record within the extended system table;
an extended acquisition table within the extended PRL;
at least one WiMAX extended acquisition record within the extended acquisition table; and
at least one CDMA extended acquisition record within the extended acquisition table.

2. The mobile station of claim 1, wherein the at least one WiMAX extended system record comprises a system record type field, and wherein the system record type field is set to a value specifically defined to indicate a WiMAX system.

3. The mobile station of claim 1, wherein the at least one WiMAX extended system record comprises a type specific system identifier (ID) record, and wherein the type specific system ID record comprises:
a network access provider ID; and
a list of network service provider IDs.

4. The mobile station of claim 1, wherein the at least one WiMAX extended acquisition record comprises an acquisition type field, and wherein the acquisition type field is set to a value specifically defined to indicate a WiMAX system.

5. The mobile station of claim 1, wherein the at least one WiMAX extended acquisition record comprises:
a band class field; and
at least one channel field that comprises a frequency assignment (FA) index.

6. The mobile station of claim 1, wherein the at least one CDMA extended system record comprises at least one CDMA 1x extended system record and at least one CDMA EV-DO extended system record, and wherein the at least one CDMA extended acquisition record comprises at least one CDMA 1x extended acquisition record and at least one CDMA EV-DO extended acquisition record.

7. A method for improved roaming for a multi-mode mobile station, comprising:
accessing an extended preferred roaming list (PRL) that comprises information about at least one CDMA system and information about at least one WiMAX system;
scanning for available systems using the CDMA system information and the WiMAX system information contained in the extended PRL; and
acquiring the at least one WiMAX system using the WiMAX system information.

8. The method of claim 7, wherein the WiMAX system information comprises at least one WiMAX extended system record within an extended system table.

9. The method of claim 8, wherein the at least one WiMAX extended system record comprises a system record type field, and wherein the system record type field is set to a value specifically defined to indicate a WiMAX system.

10. The method of claim 8, wherein the at least one WiMAX extended system record comprises a type specific system identifier (ID) record, and wherein the type specific system ID record comprises:
a network access provider ID; and
a list of network service provider IDs.

11. The method of claim 7, wherein the WiMAX system information comprises at least one WiMAX extended acquisition record within an extended acquisition table.

12. The method of claim 11, wherein the at least one WiMAX extended acquisition record comprises an acquisition type field, and wherein the acquisition type field is set to a value specifically defined to indicate a WiMAX system.

13. The method of claim 11, wherein the at least one WiMAX extended acquisition record comprises:
a band class field; and
at least one channel field that comprises a frequency assignment (FA) index.

14. The method of claim 7, wherein the information about the at least one CDMA system comprises information about at least one CDMA 1x system and information about at least one CDMA Evolution-Data Optimized (EV-DO) system.

15. A multi-mode mobile station, comprising:
means for accessing an extended preferred roaming list (PRL) that comprises information about at least one CDMA system and information about at least one WiMAX system;
means for scanning for available systems using the CDMA system information and the WiMAX system information contained in the extended PRL; and
means for acquiring the at least one WiMAX system using the WiMAX system information.

16. The mobile station of claim 15, wherein the WiMAX system information comprises at least one WiMAX extended system record within an extended system table.

17. The mobile station of claim 16, wherein the at least one WiMAX extended system record comprises a system record type field, and wherein the system record type field is set to a value specifically defined to indicate a WiMAX system.

18. The mobile station of claim 16, wherein the at least one WiMAX extended system record comprises a type specific system identifier (ID) record, and wherein the type specific system ID record comprises:
a network access provider ID; and
a list of network service provider IDs.

19. The mobile station of claim 15, wherein the WiMAX system information comprises at least one WiMAX extended acquisition record within an extended acquisition table.

20. The mobile station of claim 19, wherein the at least one WiMAX extended acquisition record comprises an acquisition type field, and wherein the acquisition type field is set to a value specifically defined to indicate a WiMAX system.

21. The mobile station of claim 19, wherein the at least one WiMAX extended acquisition record comprises:
a band class field; and
at least one channel field that comprises a frequency assignment (FA) index.

22. The mobile station of claim 15, wherein the information about the at least one CDMA system comprises information about at least one CDMA 1x system and information about at least one CDMA Evolution-Data Optimized (EV-DO) system.

23. A computer-program product comprising a computer-readable medium having instructions thereon, the instructions comprising:
code for accessing an extended preferred roaming list (PRL) that comprises information about at least one CDMA system and information about at least one WiMAX system;
code for scanning for available systems using the CDMA system information and the WiMAX system information contained in the extended PRL; and
code for acquiring the at least one WiMAX system using the WiMAX system information.

24. The computer-program product of claim 23, wherein the WiMAX system information comprises at least one WiMAX extended system record within an extended system table.

25. The computer-program product of claim 23, wherein the WiMAX system information comprises at least one WiMAX extended acquisition record within an extended acquisition table.
